(19) United States
(12) Patent Application Publication
(10) Pub. No.: US 2016/0323012 A1
(43) Pub. Date: Nov. 3, 2016

(54) METHOD AND DEVICE FOR SENDING AND RECEIVING DATA OVER MESH NETWORK USING BLUETOOTH

(71) Applicant: LG ELECTRONICS INC., Seoul (KR)

(72) Inventors: Younghwan KWON, Seoul (KR); Jinkwon LIM, Seoul (KR); Jingu CHOI, Seoul (KR)

(73) Assignee: LG ELECTRONICS INC., Seoul (KR)

(21) Appl. No.: 15/141,911

(22) Filed: Apr. 29, 2016

Related U.S. Application Data
(60) Provisional application No. 62/154,741, filed on Apr. 30, 2015.
(60) Provisional application No. 62/180,068, filed on Jun. 16, 2015.
(60) Provisional application No. 62/191,545, filed on Jul. 13, 2015.

(51) Int. Cl. H04B 1/7143; H04L 29/06; H04B 3/36; H04L 5/00; H04L 12/933; H04W 4/00

(52) U.S. Cl. CPC H04B 1/7143; H04L 49/1584; H04W 4/008; H04B 3/36; H04L 5/0055; H04L 69/28

(57) ABSTRACT

A method for transmitting data from a first device to a second device over a Bluetooth mesh network, includes receiving a first message from at least one device among the second device and a relay device included in the Bluetooth mesh network, in order to calculate the number of hops between the first and second devices, calculating the number of hops based on the first message, and transmitting a second message containing the number of hops and data to at least one device among the second device and the relay device, wherein the first message contains at least one between a maximum hop value indicating the maximum number of hops in the mesh network or a relay value indicating the number of relays for the first message.

### CROSS-REFERENCE TO RELATED APPLICATIONS

This application priority to Provisional Application No. 62/154,741 filed on 30 Apr. 2015, No. 62/191,545 filed on 13 Jul. 2015 and No. 62/180,068 filed on 16 Jun. 2015 in US the entire contents of which is hereby incorporated by reference in its entirety.

### BACKGROUND OF THE INVENTION

1. Field of the Invention

The present invention relates to a method and device for transmitting and receiving data over a mesh network using Bluetooth—a short-range technology for wireless communication systems. More particularly, the present invention relates to a method and device for sending and receiving data by calculating the distance between a source device and a destination device in a Bluetooth mesh network.

2. Discussion of the Related Art

Bluetooth is a short-range wireless technology standard that can wirelessly connect various types of devices and allows them to exchange data over short distances. To enable wireless communication between two devices using Bluetooth communication, a user has to perform the process of discovering Bluetooth devices to communicate with and making a connection request. As used herein, the term “device” refers to an appliance or equipment.

Here, the user may discover a Bluetooth device according to a Bluetooth communication method intended to be used using the Bluetooth device, and subsequently perform a connection.

The Bluetooth communication method may be classified as a BR/EDR method and an LE method. The BR/EDR method may be termed Bluetooth Classic. The Bluetooth Classic method includes a Bluetooth technology led from Bluetooth 1.0 and a Bluetooth technology using an enhanced data rate (EDR) supported by Bluetooth 2.0 or a subsequent version.

A Bluetooth low energy (LE) technology applied, starting from Bluetooth 4.0, may stably provide information of hundreds of kilobytes (KB) at low power consumption. Such a Bluetooth low energy technology allows devices to exchange information with each other by utilizing an attribute protocol. The Bluetooth LE method may reduce energy consumption by reducing overhead of a header and simplifying an operation.

Among the Bluetooth devices, some products do not have a display or a user interface. Complexity of connection, management, control, and disconnection among various types of Bluetooth devices and Bluetooth device employing similar technologies has increased.

Bluetooth supports a high speed at relatively low power consumption and at relatively low cost. However, since a transmission distance thereof is 100 m at the maximum, and thus, Bluetooth is appropriately used within a limited space.

### SUMMARY OF THE INVENTION

An aspect of the present invention is to provide a method and device for sending and receiving data using Bluetooth LE (Low Energy) technology.

Another aspect of the present invention is to provide a method and device of forming a mesh network using Bluetooth.

Yet another aspect of the present invention is to provide a method and device for calculating the number of hops between a source device and a destination device in a mesh network using Bluetooth LE technology.

A further aspect of the present invention is to provide a method for sending and receiving data using a flooding technique, via a calculated number of hops in a mesh network using Bluetooth LE technology.

A further aspect of the present invention is to provide a method and device for checking if data is transmitted properly during data transfer by receiving data relayed from nearby devices.

Technical problems to be solved by this specification are not limited to the aforementioned technical problems, and other technical problems, which are not mentioned above, will be clearly understood by those skilled in the art from the following disclosure.

One exemplary embodiment of the present invention provides a method for transmitting data from a first device to a second device over a Bluetooth mesh network, the method including: receiving a first message from at least one device among the second device and a relay device included in the Bluetooth mesh network, in order to calculate the number of hops between the first and second devices; calculating the number of hops based on the first message; and transmitting a second message containing the number of hops and data to at least one device among the second device or a relay device, wherein the first message contains at least one between a maximum hop value indicating the maximum number of hops in the mesh network or a relay value indicating the number of relays for the first message.

a initial value of the relay value is equal to the maximum hop value, and decreases each time the first message is retransmitted.

The number of hops is the maximum hop value minus the relay value.

The first message is periodically transmitted, and further contains at least one between transmission interval information indicating the transmission interval of the first message or time information indicating an expiry time for determining whether the second device is present in the mesh network.

The method further includes erasing the first device's information if the first message is not received until the expiry time.

The initial relay value is set to ‘1’, and increases each time the first message is retransmitted.

The number of hops is set equal to the relay value.

The number of hops decreases each time the second message is transmitted.

The second message further contains address information indicating the address of the second device in the Bluetooth mesh network.

The method further includes retransmitting the second message to at least one device among the second device and relay devices, if the second message is not received from at least one device among the second device and relay devices for a specific amount of time.

Another exemplary embodiment of the present invention provides a method for sending data from a first device to a second device over a Bluetooth mesh network, the method including: transmitting a request message to request the second device to assign an address to the first device in the Bluetooth mesh network; receiving from the second device a first response message containing first address information indicating the assigned address; transmitting a second response message indicating the reception of the first address information to the second device; and broadcasting an acknowledgment message containing the first address information, wherein the acknowledgment message contains time information indicating the expiry time of the first address information.

The method further includes, if the first address information is identical to second address information indicating the address of at least one device included in the Bluetooth mesh network, receiving a third response message from the at least one device, indicating that the first address information is identical to the second address information.

The third response message contains second time information indicating the expiry time of the second address information.

Yet another exemplary embodiment of the present invention provides a device which uses a method for transmitting data from a first device to a second device over a Bluetooth mesh network, the device including: a communication part for communicating with external devices in a wireless or wired manner; and a processor functionally connected to the communication part, wherein the processor controls the operation of receiving a first message from at least one device among the second device and a relay device included in the Bluetooth mesh network, in order to calculate the number of hops between the first and second devices, the operation of calculating the number of hops based on the first message, and the operation of transmitting a second message containing the number of hops and data to at least one device among the second device or the relay device, wherein the first message contains at least one between a maximum hop value indicating the maximum number of hops in the mesh network or a relay value indicating the number of relays for the first message.

According to a method for sending and receiving data over a Bluetooth mesh network according to one exemplary embodiment of the present invention, the minimum number of hops that enables data transfer between a source device and a destination device can be calculated.

According to the present invention, data can be delivered to a destination device via as few relays as possible in a Bluetooth mesh network, since the data is sent via a calculated number of hops.

According to the present invention, the relay role of a device can be turned “ON” or “OFF” by setting the role of the device in the Bluetooth mesh network.

According to the present invention, it is possible to ensure that data is being relayed properly in the Bluetooth mesh network by checking if nearby devices are relaying the data after it is sent.

Advantages and effects of the present invention are not limited to the foregoing contents and any other technical effects not mentioned herein may be easily understood by a person skilled in the art from the present disclosure and accompanying drawings.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating an example of a wireless communication system using a Bluetooth low energy technology to which the present invention is applicable;

FIG. 2 is an internal block diagram of an example of devices to which the present invention is applicable;

FIG. 3 is a view illustrating an example of a Bluetooth low energy topology;

FIG. 4 is a view illustrating an example of a Bluetooth communication architecture to which the present invention is applicable;

FIG. 5 is a view illustrating an example of a structure of a generic attribute profile (GATT) of Bluetooth low energy;

FIG. 6 is a schematic view illustrating an example of a Bluetooth mesh network to which the present invention is applicable;

FIGS. 7 and 8 are views illustrating an example of data transfer using a flooding technique over a Bluetooth mesh network to which the present invention is applicable;

FIG. 9 is a view illustrating an example of a protocol stack of a Bluetooth mesh network to which the present invention is applicable;

FIG. 10 is a flowchart illustrating an example of a method for a device to join a Bluetooth mesh network to which the present invention is applicable;

FIGS. 11 and 12 are flowcharts illustrating an example of a device's operation in a Bluetooth mesh network to which the present invention is applicable;

FIGS. 13 and 14 are flowcharts illustrating another example of a device's operation in a Bluetooth mesh network to which the present invention is applicable;

FIGS. 15 and 16 are views illustrating an example of the characteristics of Bluetooth LE to which the present invention is applicable;

FIG. 17 is a flowchart illustrating an example of a method for setting up a function supported by a device in a Bluetooth mesh network to which the present invention is applicable;

FIGS. 18 through 21 are flowcharts illustrating an example of a method for setting the address of a device in a Bluetooth mesh network to which the present invention is applicable;

FIG. 22 is a view illustrating an example of a method for calculating the number of hops between devices in a Bluetooth mesh network to which the present invention is applicable;

FIG. 23 is a view illustrating an example of a method for sending data via a calculated number of hops in a Bluetooth mesh network to which the present invention is applicable;

FIG. 24 is a flowchart illustrating an example of a method for calculating the number of hops and sending a device's information in a Bluetooth mesh network to which the present invention is applicable;

FIG. 25 is a flowchart illustrating an example of a method of relaying a received message that is redundant, in a Bluetooth mesh network to which the present invention is applicable;

FIG. 26 is a view illustrating an example of a method of checking if a sent message has been received properly by nearby devices to which the present invention is applicable;

FIG. 27 is a view illustrating another example of a method of checking if a sent message has been received properly by nearby devices to which the present invention is applicable; and

FIG. 28 is a view illustrating yet another example of a method of checking if a sent message has been received properly by nearby devices to which the present invention is applicable.

### DETAILED DESCRIPTION OF THE EMBODIMENTS

The aforementioned objects, features and advantages of the present invention will become more apparent through the following detailed description with respect to the accompanying drawings. Hereinafter, the embodiments of the present invention will be described with reference to the accompanying drawings, in which like numbers refer to like elements throughout the specification. In describing the present invention, a detailed description of known techniques associated with the present invention unnecessarily obscure the gist of the present invention, it is determined that the detailed description thereof will be omitted.

Hereinafter, a terminal related to the present invention will be described in detail with reference to the accompanying drawings. In the following description, usage of suffixes such as ‘module’, ‘part’ or ‘unit’ used for referring to elements is given merely to facilitate explanation of the present invention, without having any significant meaning by itself.

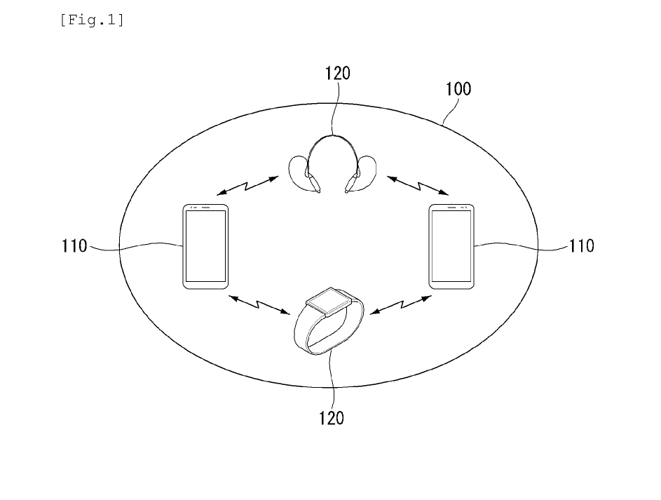

FIG. 1 is a schematic view illustrating an example of a wireless communication system using a Bluetooth low energy technology to which the present invention is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may also be called as data service device, slave device, slave, server, conductor, host device, gateway, sensing device, monitoring device, first device, or the like, and the client device 110 may also be called as master device, master, client, member, sensor device, sink device, collector, second device, third device, and the like.

The server device and the client device correspond to major components of the wireless communication system, and the wireless communication system may include components other than the server device and the client device.

The server device refers to a device which receives data from the client device and provides data to the client device in response when a corresponding request is received from the client device, through direct communication with the client device.

Also, in order to provide data information to the client device, the server device sends a notification message or an indication message to the client device in order to provide data information to the client device. Also, the server device receives a confirmation message corresponding to the indication message from the client device.

Also, in the process of transmitting and receiving notification, indication, and confirmation messages to and from the client device, the server device may provide data information to a user through a display unit or may receive a request input from the user through a user input interface.

Also, in the process of transmitting and receiving message to and from the client device, the server device may read data from a memory unit or may write new data to the corresponding memory unit.

Also, the single server device may be connected with a plurality of client devices, and may be easily re-connected with client devices using bonding information.

The client device 120 refers to a device which requests data information and data transmission from the server device.

The client device receives data through a notification message or an indication message from the server device, and when an indication message is received from the server device, the client device sends an acknowledgement message in response to the indication message.

Similarly, in the process of transmitting and receiving messages to and from the server device, the client device may also provide information to the user through a display unit or may receive an input from the user through a user input interface.

Also, in the process of transmitting and receiving messages with the server device, the client device may read data from a memory unit or may write new data to the corresponding memory unit.

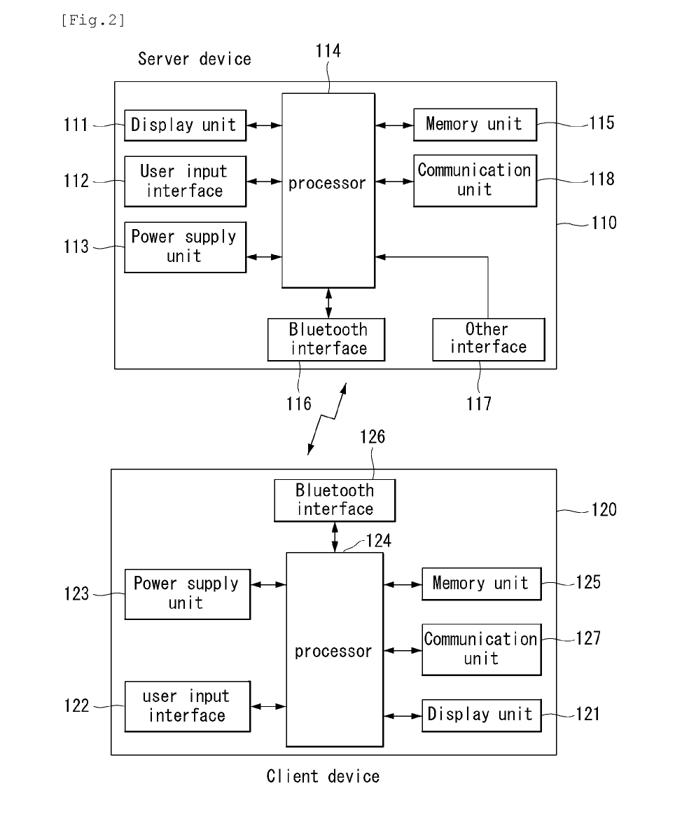

Hardware components such as the display units, the user input interfaces, and the memory units of the server device and the client device will be described in detail with reference to FIG. 2.

Also, the wireless communication system may configure personal area networking (PAN) through the Bluetooth technology. For example, in the wireless communication system, a private piconet may be established between devices to quickly and safely exchange files, documents, and the like.

FIG. 2 is an internal block diagram of an example of devices to which the present invention is applicable.

As illustrated in FIG. 2, a server device includes a display unit 111, a user input interface 112, a power supply unit 113, a processor 114, a memory unit 115, a Bluetooth interface 116, other interface 117, and a communication unit (or transceiver unit) 118.

The display unit 111, the user input interface 112, the power supply unit 113, the processor 114, the memory unit 115, the Bluetooth interface 116, other interface 117, and the communication unit 118 are functionally connected to each other to perform a method proposed in this disclosure.

Also, the client device includes a display unit 121, a user input interface 122, a power supply unit 123, a processor 124, a memory unit 125, a Bluetooth interface 126, and a communication unit (or transceiver unit) 128.

The display unit 121, the user input interface 122, the power supply unit 123, the processor 124, the memory unit 125, the Bluetooth interface 126, other interface 127, and the communication unit 128 are functionally connected to each other to perform a method proposed in this disclosure.

The Bluetooth interfaces 116 and 126 refer to units (or modules) able to transmit data such as a request/a response, a command, a notification, an indication/confirmation message between devices.

The memory units 115 and 126 are units implemented in various types of devices, in which various types of data are stored.

The processors 114 and 124 refer to modules controlling a general operation of the server device or the client device, which control requesting transmission of a message through the Bluetooth interface and other interface and processing a received message therethrough.

The processors 114 and 124 may also be termed a controller, a control unit, and the like.

The processors 114 and 124 may include an application-specific integrated circuit (ASIC), other chip set, a logic circuit and/or data processing unit.

The processors 114 and 124 control the communication units to receive an advertising message from the server device, control the communication unit to transmit a scan request message to the server device and receive a scan response message as a response to the scan request from the server device, and control the communication unit to transmit a connection request message to the server device in order to establish a Bluetooth connection with the server device.

Also, after the Bluetooth LE connection is established through the connection procedure, the processors 114 and 124 control the communication units to read or write data by using an attribute protocol from the server device

The memory units 115 and 125 may include a read-only memory (ROM), a random access memory (RAM), a flash memory, a memory card, a storage medium and/or other storage device.

The communication units 118 and 127 may include a baseband circuit for processing a wireless signal. When an embodiment is implemented by software, the aforementioned technique may be implemented as a module (process, function, etc.) performing the aforementioned function. The module may be stored in a memory unit and may be executed by a processor.

The memory units 115 may be present within or outside of the processors 114 and 124, and may be connected to the processors 114 and 124 through various well-known units.

The display units 111 and 121 refer to modules providing status information of the devices, message exchange information, and the like, to the user through a screen.

The power supply units 113 and 123 refer to modules receiving external power or internal power and supplying power required for operations of the respective components under the control of the controllers 114 and 124.

As discussed above, in the BLE technology, a duty cycle is small and power consumption may be significantly reduced through a low data rate, and thus, the power supply unit may supply power required for operations of the respective components even with small output power (10 mW (10 dBm) or less).

The user input interfaces 112 and 122 refer to modules providing a user input such as a screen button to the controllers to enable the user to control an operation of the devices.

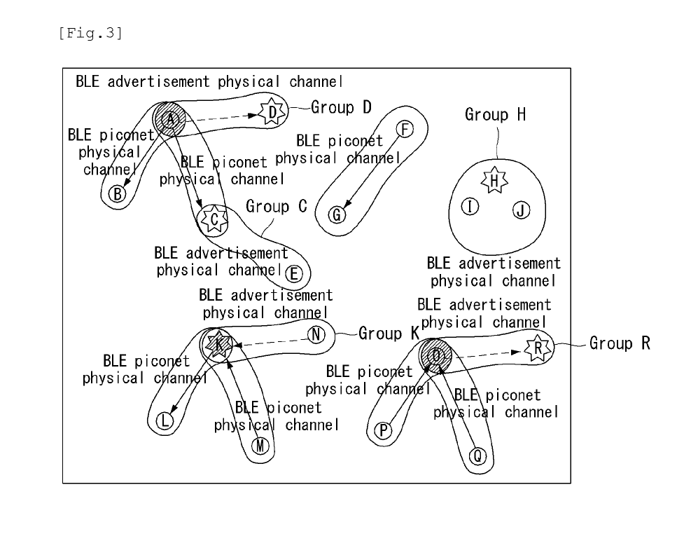

FIG. 3 is a view illustrating an example of a Bluetooth low energy topology.

Referring to FIG. 3, a device A corresponds to a master in a piconet (piconet A, the shaded portion) having a device B and a device C as slaves.

Here, the piconet refers to an aggregation of devices in which any one of them is a mater and the other devices occupy a shared physical channel connected to the master device.

The BLE slave does not share a common physical channel with the master. Each of the slaves communicates with the master trough a separate physical channel. There is another piconet (piconet F) having a master device F and a slave device G.

A device K is present in a scatternet K. Here, the scatternet refers to a group of piconets connected to other piconets.

The device K is a master of a device L and a slave of a device M.

A device O is also in the scatter net O. The device O is a slave of a device P and a slave of a device Q.

As illustrated in FIG. 2, five different device groups are present.
1. Device D is an advertiser and device A is an initiator (group D).
2. Device E is a scanner and Device C is an advertiser (group C).
3. Device H is an advertiser, and devices I and J are scanners (group H).
4. Device K is also an advertiser, and device N is an initiator (group K).
5. Device R is an advertiser, and device O is an initiator (group R).

The devices A and B use a single BLE piconet physical channel.

The devices A and C use another BLE piconet physical channel.

In group D, the device D advertises using an advertisement event connectable in an advertisement physical channel, and the device A is an initiator. The device A may establish a connection with the device D and add a device to the piconet A.

In group C, the device C advertises on an advertisement physical channel by using a certain type of an advertisement event captured by the scanner device E.

The group D and the group C may use different advertisement physical channels or different times in order to avoid collision.

In the piconet F, a single physical channel is present. The devices F and G use a single BLE piconet physical channel. The device F is a master, and the device G is a slave.

In group H, a single physical channel is present. The devices H, I, and J use a single BLE advertisement physical channel. The device H is an advertiser, and the devices I and J are scanners.

In the scatternet K, the devices K and L use a single BLE piconet physical channel. The devices K and M use another BLE piconet physical channel.

In group K, the device K advertises by using an advertisement event connectable on an advertisement physical channel, and the device N is an initiator. The device N may establish a connection with the device K. Here, the device K may be a slave of two devices and a master of one device at the same time.

In the scatternet O, the devices O and P use a single BLE piconet physical channel. The devices O and Q use another BLE piconet physical channel.

In group R, the device R advertises by using an advertisement event connectable on an advertisement physical channel, and the device O is an initiator. The device O may establish a connection with the device R. Here, the device O may be a slave of two devices and a master of one device at the same time.

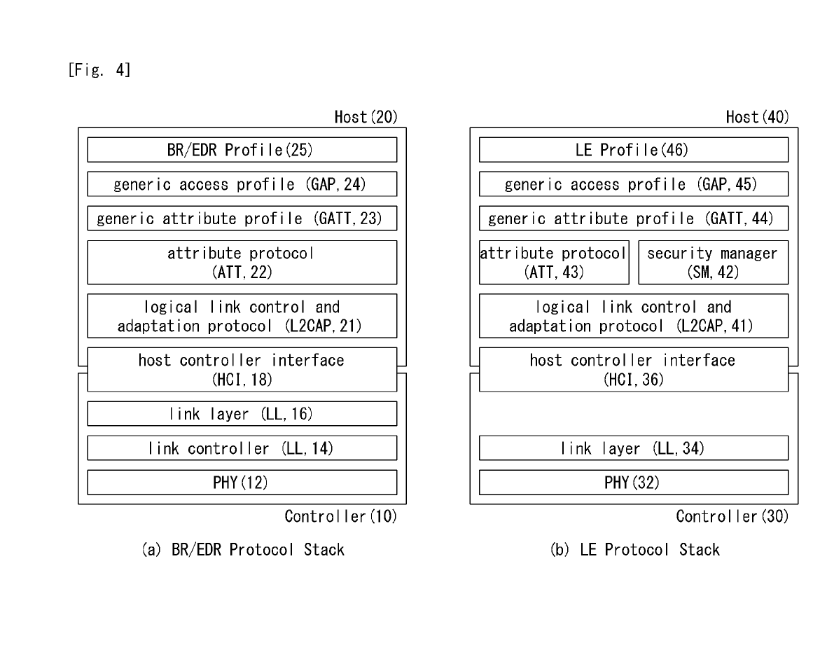

As illustrated in (b) of FIG. 4, the Bluetooth LE protocol stack includes a controller stack 30 operable to process a wireless device interface for which timing is important, and a host stack 40 operable to process high level data.

First, the controller stack 30 may be implemented by using a communication module that may include a Bluetooth wireless device, for example, a processor module that may include a processing device such as a microprocessor.

The host stack may be implemented as part of an OS operated on a processor module or may be implemented as instantiation of a package on the OS.

In some examples, the controller stack and the host stack may be operated or executed on the same processing device within a processor module.

The controller stack 30 includes a physical layer (PHY) 32, a link layer (LL) 34, and a host controller interface (HCI) 36.

The physical layer (PHY) (wireless transceiver module 32), a layer for transmitting and receiving a 2.4 GHz wireless signal, uses a Gaussian frequency shift keying (GFSK) modulation and a frequency hopping technique including forty RF channels.

The link layer (LL) 34 serving to transmit or receive a Bluetooth packet provides a function of generating a connection between devices after performing an advertising and scanning function using three advertising channels, and exchanging data packets of a maximum of 257 bytes through thirty-seven data channels.

The host stack may include a generic access profile (GAP) 40, a logical link control and adaptation protocol (L2CAP) 41, a security manager (SM) 42, an attribute protocol (ATT) 43), a generic attribute profile (GATT) 44, a generic access profile (GAP) 45, and an LE profile 46. However, the host stack 40 is not limited thereto and may include various protocols and profiles.

The host stack multiplexes various protocols and profiles provided from a Bluetooth higher position by using the L2CAP.

First, the L2CAP 41 may provide a single two-way channel for transmitting data to a specific protocol or profile.

The L2CAP 41 may operate to multiplex data between higher layer protocols, segment and reassemble packages, and manage a multicast data transmission.

In the Bluetooth LE, three fixed channels (one for a signaling channel, one for a security manager, and one for an attribute protocol) are used.

In contrast, in the BR/EDR, a dynamic channel is used, and a protocol service multiplexer, retransmission, streaming mode, and the like, are supported.

The SM 42 is a protocol for certifying a device and providing a key distribution.

The ATT 43 defines a rule for accessing data of a counterpart device by a server-client structure. The ATT 43 includes six types of messages (request, response, command, notification, indication, and confirmation) as follows.

[symbol] Request and Response message: A request message is a message for a client device to request specific information from a server device, and the response message, as a response message with respect to the request message, refers to a message transmitted from the server device to the client device.

[symbol] Command message: It is a message transmitted from the client device to the server device in order to indicate a command of a specific operation. The server device does not transmit a response with respect to the command message to the client device.

[symbol] Notification message: It is a message transmitted from the server device to the client device in order to notify an event, or the like. The client device does not transmit a confirmation message with respect to the notification message to the server device.

[symbol] Indication and confirmation message: It is a message transmitted from the server device to the client device in order to notify an event, or the like. Unlike the notification message, the client device transmits a confirmation message regarding the indication message to the server device.

In the present invention, when the GATT profile using the attribute protocol (ATT) 43 requests long data, a value regarding a data length is transmitted to allow a client to clearly know the data length, and a characteristic value may be received from a server by using a universal unique identifier (UUID).

The generic access profile (GAP) 45, a layer newly implemented for the Bluetooth LE technology, is used to select a role for communication between Bluetooth LED devices and to control how a multi-profile operation takes place.

Also, the generic access profile (GAP) 45 is mainly used for device discovery, connection generation, and security procedure part, defines a scheme for providing information to a user, and defines types of attributes as follows.

[symbol] Service: It defines a basic operation of a device by a combination of behaviors related to data

[symbol] Include: It defines a relationship between services

[symbol] Characteristics: It is a data value used in a server

[symbol] Behavior: It is a format that may be read by a computer defined by a UUID (value type).

The LE profile 46, including profiles dependent upon the GATT, is mainly applied to a Bluetooth LE device. The LE profile 46 may include, for example, Battery, Time, FindMe, Proximity, Time, Object Delivery Service, and the like, and details of the GATT-based profiles are as follows.

Battery: Battery information exchanging method

Time: Time information exchanging method

FindMe: Provision of alarm service according to distance

Proximity: Battery information exchanging method

Time: Time information exchanging method

The generic attribute profile (GATT) 44 may operate as a protocol describing how the attribute protocol (ATT) 43 is used when services are configured. For example, the GATT 44 may operate to define how ATT attributes are grouped together with services and operate to describe features associated with services.

Thus, the GATT 44 and the ATT 43 may use features in order to describe status and services of a device and describe how the features are related and used.

Hereinafter, procedures of the Bluetooth low energy (BLE) technology will be briefly described.

The BLE procedure may be classified as a device filtering procedure, an advertising procedure, a scanning procedure, a discovering procedure, and a connecting procedure.

Device Filtering Procedure

The device filtering procedure is a method for reducing the number of devices performing a response with respect to a request, indication, notification, and the like, in the controller stack.

When requests are received from all the devices, it is not necessary to respond thereto, and thus, the controller stack may perform control to reduce the number of transmitted requests to reduce power consumption.

An advertising device or scanning device may perform the device filtering procedure to limit devices for receiving an advertising packet, a scan request or a connection request.

Here, the advertising device refers to a device transmitting an advertisement event, that is, a device performing an advertisement and is also termed an advertiser.

The scanning device refers to a device performing scanning, that is, a device transmitting a scan request.

In the BLE, in a case in which the scanning device receives some advertising packets from the advertising device, the scanning device should transmit a scan request to the advertising device.

However, in a case in which a device filtering procedure is used so a scan request transmission is not required, the scanning device may disregard the advertising packets transmitted from the advertising device.

Even in a connection request process, the device filtering procedure may be used. In a case in which device filtering is used in the connection request process, it is not necessary to transmit a response with respect to the connection request by disregarding the connection request.

Advertising Procedure

The advertising device performs an advertizing procedure to perform undirected broadcast to devices within a region.

Here, the undirected broadcast is advertizing toward all the devices, rather than broadcast toward a specific device, and all the devices may scan advertising to make an additional information request or a connection request.

In contrast, directed advertising may make an additional information request or a connection request by scanning advertising for only a device designated as a reception device.

The advertising procedure is used to establish a Bluetooth connection with an initiating device nearby.

Or, the advertising procedure may be used to provide periodical broadcast of user data to scanning devices performing listening in an advertising channel.

In the advertising procedure, all the advertisements (or advertisement events) are broadcast through an advertisement physical channel.

The advertising devices may receive scan requests from listening devices performing listening to obtain additional user data from advertising devices. The advertising devices transmit responses with respect to the scan requests to the devices which have transmitted the scan requests, through the same advertising physical channels as the advertising physical channels in which the scan requests have been received.

Broadcast user data sent as part of advertising packets are dynamic data, while the scan response data is generally static data.

The advertisement device may receive a connection request from an initiating device on an advertising (broadcast) physical channel. If the advertising device has used a connectable advertising event and the initiating device has not been filtered according to the device filtering procedure, the advertising device may stop advertising and enter a connected mode. The advertising device may start advertising after the connected mode.

Scanning Procedure

A device performing scanning, that is, a scanning device performs a scanning procedure to listen to undirected broadcasting of user data from advertising devices using an advertising physical channel.

The scanning device transmits a scan request to an advertising device through an advertising physical channel in order to request additional data from the advertising device. The advertising device transmits a scan response as a response with respect to the scan request, by including additional user data which has requested by the scanning device through an advertising physical channel.

The scanning procedure may be used while being connected to other BLE device in the BLE piconet.

If the scanning device is in an initiator mode in which the scanning device may receive an advertising event and initiates a connection request. The scanning device may transmit a connection request to the advertising device through the advertising physical channel to start a Bluetooth connection with the advertising device.

When the scanning device transmits a connection request to the advertising device, the scanning device stops the initiator mode scanning for additional broadcast and enters the connected mode.

Discovering Procedure

Devices available for Bluetooth communication (hereinafter, referred to as “Bluetooth devices”) perform an advertising procedure and a scanning procedure in order to discover devices located nearby or in order to be discovered by other devices within a given area.

The discovering procedure is performed asymmetrically. A Bluetooth device intending to discover other device nearby is termed a discovering device, and listens to discover devices advertising an advertising event that may be scanned. A Bluetooth device which may be discovered by other device and available to be used is termed a discoverable device and positively broadcasts an advertising event such that it may be scanned by other device through an advertising (broadcast) physical channel.

Both the discovering device and the discoverable device may have already been connected with other Bluetooth devices in a piconet.

Connecting Procedure

A connecting procedure is asymmetrical, and requests that, while a specific Bluetooth device is performing an advertising procedure, another Bluetooth device should perform a scanning procedure.

That is, an advertising procedure may be aimed, and as a result, only one device may response to the advertising. After a connectable advertising event is received from an advertising device, a connecting request may be transmitted to the advertising device through an advertising (broadcast) physical channel to initiate connection.

Hereinafter, operational states, that is, an advertising state, a scanning state, an initiating state, and a connection state, in the BLE technology will be briefly described.

Advertising State

A link layer (LL) enters an advertising state according to an instruction from a host (stack). In a case in which the LL is in the advertising state, the LL transmits an advertising packet data unit (PDU) in advertising events.

Each of the advertising events include at least one advertising PDU, and the advertising PDU is transmitted through an advertising channel index in use. After the advertising PDU is transmitted through an advertising channel index in use, the advertising event may be terminated, or in a case in which the advertising device may need to secure a space for performing other function, the advertising event may be terminated earlier.

Scanning State

The LL enters the scanning state according to an instruction from the host (stack). In the scanning state, the LL listens to advertising channel indices.

The scanning state includes two types: passive scanning and active scanning. Each of the scanning types is determined by the host.

Time for performing scanning or an advertising channel index are not defined.

During the scanning state, the LL listens to an advertising channel index in a scan window duration. A scan interval is defined as an interval between start points of two continuous scan windows.

When there is no collision in scheduling, the LL should listen in order to complete all the scan intervals of the scan window as instructed by the host. In each scan window, the LL should scan other advertising channel index. The LL uses every available advertising channel index.

In the passive scanning, the LL only receives packets and cannot transmit any packet.

In the active scanning, the LL performs listening in order to be relied on an advertising PDU type for requesting advertising PDUs and advertising device-related additional information from the advertising device.

Initiating State

The LL enters the initiating state according to an instruction from the host (stack).

When the LL is in the initiating state, the LL performs listening on advertising channel indices.

During the initiating state, the LL listens to an advertising channel index during the scan window interval.

Connection State

When the device performing a connection state, that is, when the initiating device transmits a CONNECT_REQ PDU to the advertising device or when the advertising device receives a CONNECT_REQ PDU from the initiating device, the LL enters a connection state.

It is considered that a connection is generated after the LL enters the connection state. However, it is not necessary to consider that the connection should be established at a point in time at which the LL enters the connection state. The only difference between a newly generated connection and an already established connection is a LL connection supervision timeout value.

When two devices are connected, the two devices play different roles.

An LL serving as a master is termed a master, and an LL serving as a slave is termed a slave. The master adjusts a timing of a connecting event, and the connecting event refers to a point in time at which the master and the slave are synchronized.

Hereinafter, packets defined in an Bluetooth interface will be briefly described. BLE devices use packets defined as follows.

Packet Format

The LL has only one packet format used for both an advertising channel packet and a data channel packet.

Each packet includes four fields of a preamble, an access address, a PDU, and a CRC.

When one packet is transmitted in an advertising physical channel, the PDU may be an advertising channel PDU, and when one packet is transmitted in a data physical channel, the PDU may be a data channel PDU.

Advertising Channel PDU

An advertising channel PDU has a 16-bit header and payload having various sizes.

A PDU type field of the advertising channel PDU included in the heater indicates PDU types defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are termed advertising PDUs and used in a specific event.
ADV_IND: Connectable undirected advertising event
ADV_DIRECT_IND: Connectable directed advertising event
ADV_NONCONN_IND: Unconnectable undirected advertising event
ADV_SCAN_IND: Scannable undirected advertising event

The PDUs are transmitted from the LL in an advertising state, and received by the LL in a scanning state or in an initiating state.

Scanning PDU

The following advertising channel DPU types are termed scanning PDUs and are used in a state described hereinafter.
SCAN_REQ: Transmitted by the LL in a scanning state and received by the LL in an advertising state.
SCAN_RSP: Transmitted by the LL in the advertising state and received by the LL in the scanning state.

Initiating PDU

The following advertising channel PDU type is termed an initiating PDU.
CONNECT_REQ: Transmitted by the LL in the initiating state and received by the LL in the advertising state.

Data Channel PDU

The data channel PDU may include a message integrity check (MIC) field having a 16-bit header and payload having various sizes.

The procedures, states, and packet formats in the BLE technology discussed above may be applied to perform the methods proposed in this disclosure.

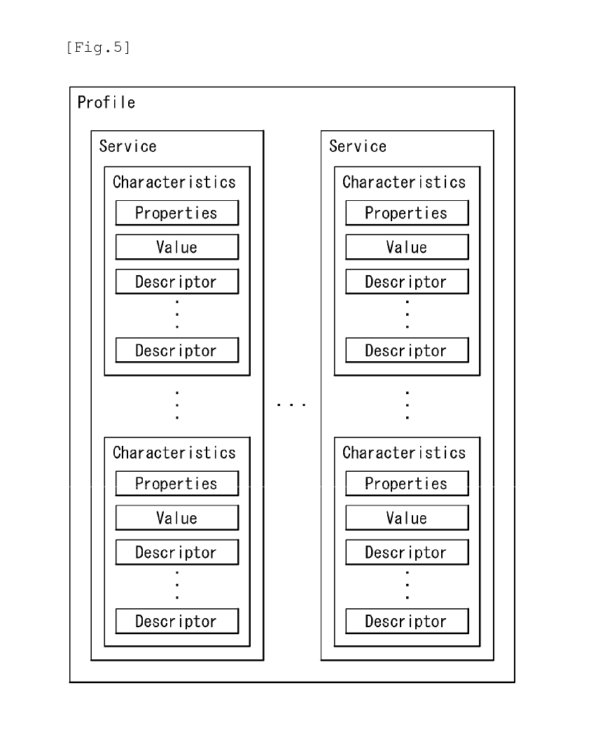

FIG. 5 is a view illustrating an example of a structure of a generic attribute profile (GATT) of Bluetooth low energy.

Referring to FIG. 5, a structure for exchanging profile data of Bluetooth low energy may be looked through.

In detail, the GATT defines a method for exchanging data using a service between Bluetooth LE devices and a characteristic.

In general, a peripheral device (for example, a sensor device) serves as a GATT server, and has definition regarding a service and a characteristic.

In order to read or write data, a GATT client sends a data request to the GATT server, and every operation (transaction) is started by the GATT client and a response is received from the GATT server.

A GATT-based operational structure used in the Bluetooth LE may be a vertical structure as illustrated in FIG. 5 on the basis of a profile, a service, and a characteristic.

The profile includes one or more services, and the services may include one or more characteristics or other services.

The service serves to divide data into logical units and may include one or more characteristics or other services, each of the services has a 16-bit or 128-bit identifier called a universal unique identifier (UUID)).

The characteristic is the lowermost unit in the GATT-based operational structure. The characteristic includes only one data, and has a 16-bit or 128-bit UUID, similar to the service.

The characteristic is defined by values of various types of information, and in order to hold each information, an attribute may be required for each information. The characteristic may use several continuous attributes.

The attribute has four components and has meanings as follows.
handle: Address of attribute
Type: Type of attribute
Value: Value of attribute
Permission: Right to access attribute

However, Bluetooth LE has variations in link quality because of its wireless transfer feature, and may have shadow areas beyond a radio-wave range because of its one-to-one connectivity. To overcome these problems, a mesh network consisting of Bluetooth-equipped devices may be formed as a means of control via multi-hop links between devices.

Hereinafter, a mesh network will be discussed.

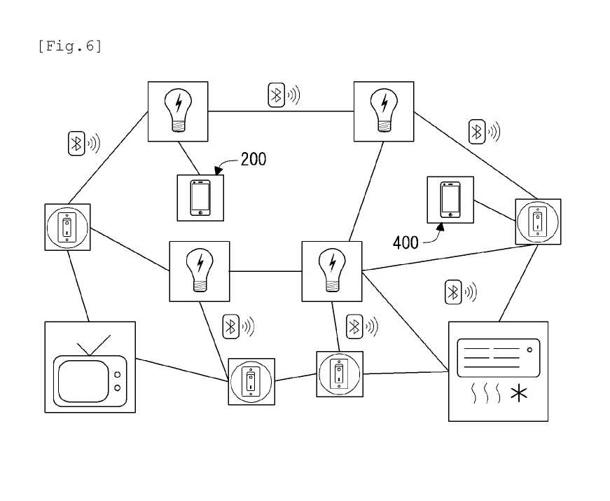

FIG. 6 is a schematic view illustrating an example of a Bluetooth mesh network to which the present invention is applicable.

As illustrated in FIG. 6, a mesh network refers to a network in which multiple devices are connected to each other and can send and receive data over Bluetooth.

A Bluetooth mesh network is made up of relay nodes that relay messages between a source device 200 that sends data and a destination device 400 that receives data.

Alternatively, the Bluetooth mesh network may include edge nodes 200 and 400 and relay nodes.

As used herein, the term “node” refers to devices that form a mesh network, and the terms “node” and “device” can be used together.

Each node has a message cache of recently received messages. If a received message is already in the message cache, this message is not relayed any longer.

However, if the received message is not in the message cache, the message is relayed and stored in the message cache.

An edge node usually get its power from a battery, and is in sleep state at normal times and may wake up for interaction or periodically.

The edge node may handle a received message if the following conditions are met:
The message is not in the message cache.
The message is authenticated by a known network key.
The destination of the message is the edge node's unicast address, a broadcast address or group address to which the edge node belongs.

A relay node is usually a device that draws main power, which is always awake and transmits received data for other nodes.

The relay node may retransmit a received message to other nodes if the following conditions are met:
The message is not in the message cache.
The message is authenticated by a known network key.
The field (e.g., relay value) indicating whether to relay the message has a value that permits relaying.
The destination address is not a unicast address assigned for the relay node.

Bluetooth mesh networks may use either a flooding technique or a routing technique, depending on how relay nodes transmit data.

In the routing technique, the source device 200 sends a message to a particular relay node, and the particular relay node, upon receiving the message, transmits the message based on information on another relay node or the destination device 400 to which the message is to be retransmitted.

The routing technique uses a broadcasting channel or point-to-point connection so as to receive and retransmit messages.

A routing device that receives a message using the routing technique determines the best routing route(s) along which the message is to be sent to an intermediate device or destination device, and decides which route to take to send the message based on a determined routing table.

With routing, however, messages need to maintain their routing tables when they are sent. Thus, the routing technique becomes more complex and requires more memory as the number of messages increase. Also, the routing technique is less dynamic and more difficult to implement than the flooding technique, but offers good extensibility.

The flooding technique refers to a technique in which relay nodes receive a message and transmit it over the air via radio waves having the characteristic of propagating into the air in all directions.

That is, the source device 200 sends a message to relay nodes via broadcast channels, and the relay nodes receive and forward the message to neighboring relay nodes so that it is delivered to the destination device 400.

The flooding technique uses a broadcast channel to receive and retransmit messages, thus extending the transmission range of messages.

A mesh network using the flooding technique is a dynamic network. In the mesh network using the flooding technique, a device can receive and transmit (or retransmit) a message at any time as long as its density allows it.

The flooding technique is easy to implement, but may have extensibility issues arising from an extended network because messages are sent directionlessly.

That is, in the mesh network using the flooding technique, when a device sends a message, multiple devices receive the message and forward the received message to other devices.

Unlike the routing technique, the flooding technique enables the transfer of a message easily without the cost of constructing a routing table, but increases network traffic because all relay devices that receive the message retransmit it.

To avoid this, the number of devices on the mesh network may be adjusted between 100 and 1,000, and the exact number of devices may be determined by a number of factors.

For example, the exact number of devices may be determined by network capacity, traffic load of data sources, network latency, reliability requirements, etc.

Alternatively, when the source device 200 sends a message, a maximum hop value may be set for the message so as to keep the message from hopping more than a certain number of times.

As used herein, the term “hop” refers to a link between devices in a Bluetooth mesh network. That is, a link between a source device and a relay device, or between relay devices, or between a relay device and a destination device, or between the source device and the destination device may be called a hop.

However, it is necessary for the destination device and relay devices involved in message transfer to know the maximum hop value, in order to efficiently transfer a message based on the maximum hop value.

To solve this problem, the present invention proposes a method of calculating the maximum hop value and a method for a device joining a mesh network to transmit its information to all the nodes in the mesh network.

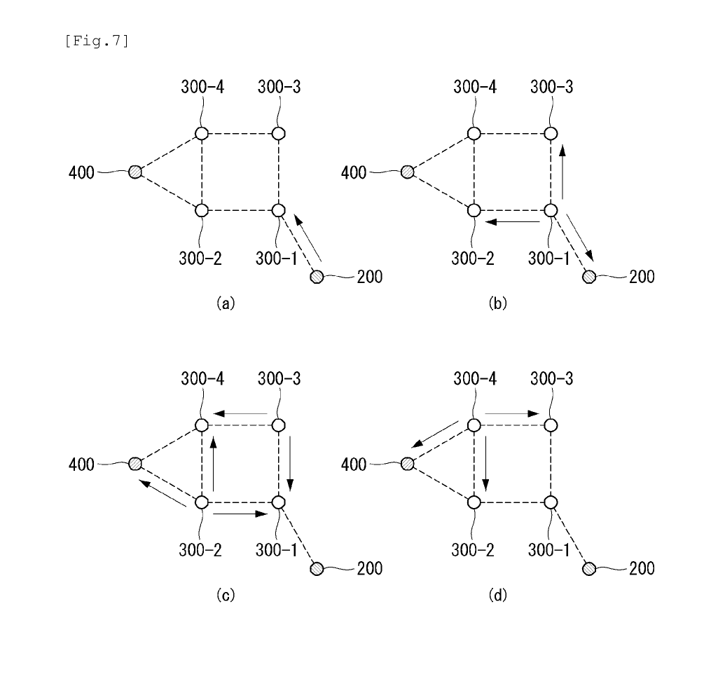

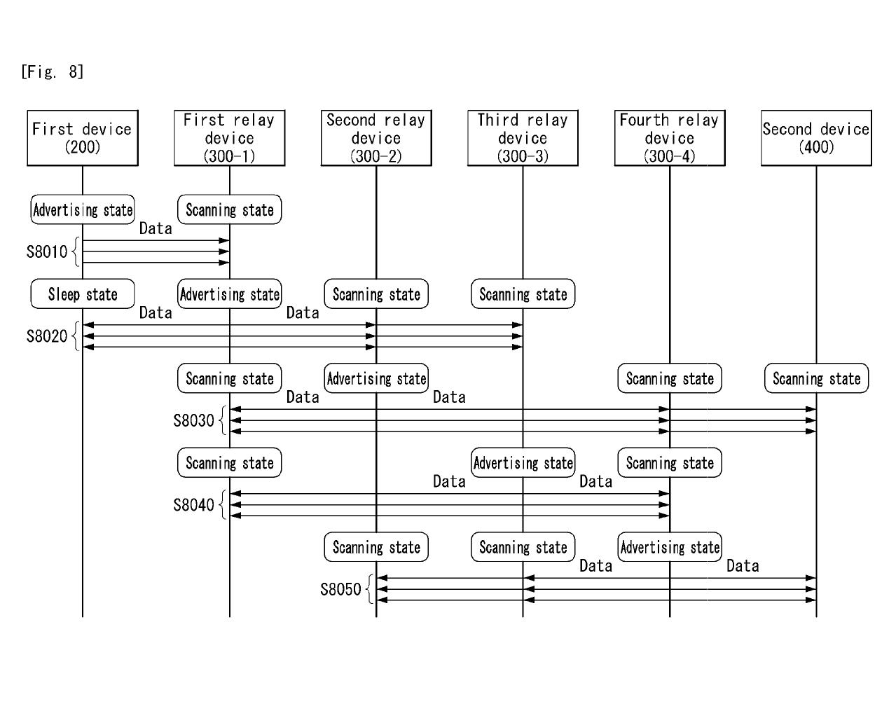

FIGS. 7 and 8 are views illustrating an example of data transfer using a flooding technique in a Bluetooth mesh network to which the present invention is applicable.

As illustrated in FIGS. 7 and 8, a method for a first device 200, i.e., a source device, to send data to a second device 400, a destination device, using a flooding technique will be described concretely. (a) If the first device 200 wants to send data to the destination device 400 using a flooding technique, the source device 200, in advertising state, broadcasts an advertising message containing the data to neighboring devices (S8010).

(b) A first relay device 300-1, in scanning state, receives the advertising message, and then changes to advertising state and broadcasts the advertising message to nearby devices (S8020).

In this case, the first device 200 cannot receive the advertising message sent from the first relay device 300-1 since it has changed to sleep state after sending the advertising message.

(c) Afterwards, second and third relay devices 300-2 and 300-3, in scanning state, receive the advertising message from the first relay device 300-1, change to advertising state, and broadcast the advertising message to nearby devices (S8030 and S8040).

Having received the advertising message from two or more relay devices, a fourth relay device 300-4 may identify the advertising message that is received later, based on the sequence number contained in it, and discard it.

For example, if the advertising message sent from the third relay device 300-3 is received later than the one sent from the second relay device 300-2, the fourth relay device 300-4 may discard the one sent from the third relay device 300-3.

The second device 400, in scanning state, may receive the advertising message through the step S8030 since it is adjacent to the second relay device 300-2.

(d) Having received the advertising message from the second relay device 300-2, the fourth relay device 300-4 may change from scanning state to advertising state and broadcast the advertising message to nearby devices (S8050).

Although the second device 400 has already received the advertising message through the step S8030, it may receive the advertising message again from the fourth relay device 300-4, i.e., another link.

In this case, the second device 400 may discard the advertising message sent from the fourth relay device 300-4.

With this method, the first device 200 may send data to the second device 400 using the flooding technique over a Bluetooth mesh network.

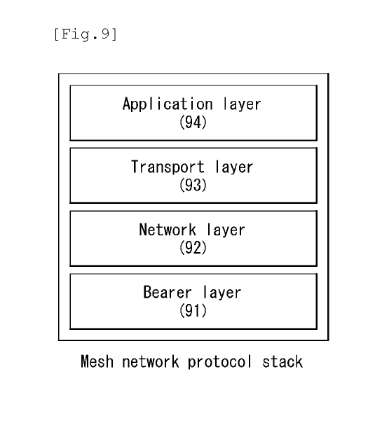

FIG. 9 is a view illustrating an example protocol stack of a Bluetooth mesh network to which the present invention is applicable.

Referring to FIG. 9, a mesh network's protocol stack includes a bearer layer 91, a network layer 92, a transport layer 93, and an application layer 94.

The bearer layer 91 defines the method of transmitting messages between nodes. That is, it determines the bearer of a message to be sent over the mesh network.

The mesh network provides an advertising bearer and a GATT bearer for message transfer.

The network layer 92 defines the method of sending a message to one or more nodes over the mesh network and the format of network messages to be carried by the bearer layer 81.

Also, the network layer 92 defines whether to relay or forward a message and the method of authentication and encryption of network messages.

The transport layer 92 provides the confidentiality of application messages and defines the method of authentication and encryption of application data.

The application layer 94 defines the method of how an upper-layer application uses the transport layer 93 and the application's operation code (Opcode) and parameters.

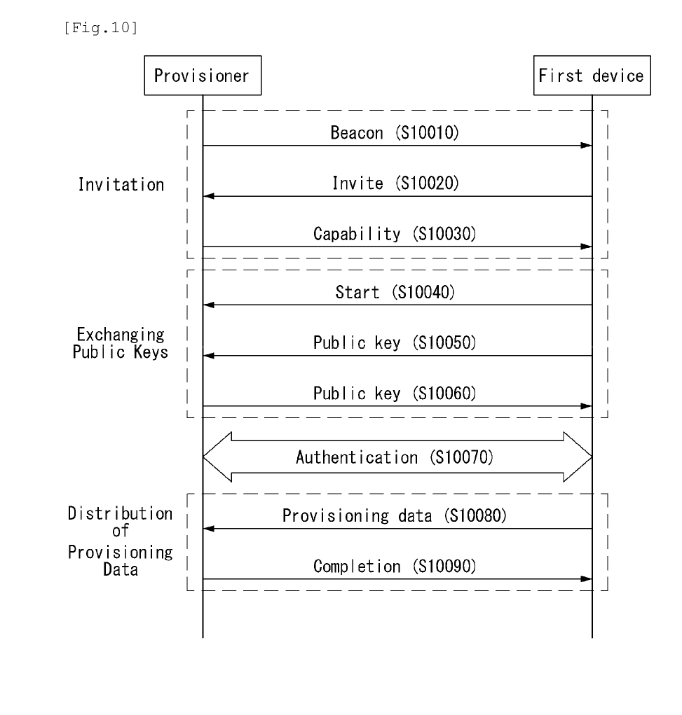

FIG. 10 is a flowchart illustrating an example of a method for a device to join a Bluetooth mesh network to which the present invention is applicable.

A new device or unprovisioned device has to go through a provisioning process in order to join a mesh network and operate.

The provisioning process refers to the process of authenticating an unauthenticated device and providing basic information (e.g., a unicast address, various types of keys, etc.) required to join the mesh network.

That is, the provisioning process is a process in which the mesh network's provisioner provides information required to join the mesh network, by which the first device can get the network address, keys, device identifier, and other various information required to operate as part of the mesh network.

The provisioning process includes an invitation step, a public key exchange step, an authentication step, a distribution-of-provisioning-data step.

The provisioning process may be performed through various types of bearers. For example, the provisioning process may be performed through an advertising-based bearer, a mesh provisioning service-based bearer, or a mesh-based bearer.

The advertising-based bearer is a bearer that is necessarily established. If the advertising-based bearer is not supported, or provisioning data cannot be sent through the advertising-based bearer, the provisioning service-based bear or mesh-based bearer may be used in the provisioning process.

The provisioning service-based bearer refers to a bearer for exchanging provisioning data through the existing GATT protocol for Bluetooth LE. The mesh-based bearer refers to a bearer for exchanging provisioning data over a mesh network when the first device 300 and the second device 400 are not within a distance over which they can directly exchange data.

The process of establishing the advertising-based bearer will be discussed later.

After the bearer is established between the first device 300 and the second device 400, the first device 300 may be provisioned through the following provisioning process.

Invitation Step

The invitation step begins as the second device 400 scans the first device 300. The first device 300 sends a beacon message to the second device 400 (S10010). The beacon message contains the UUID of the first device 300.

Having scanned the first device 300 through the beacon message, the second device 400 sends an invite message to the first device 300 (S10020).

The invite message asks the first device 300 whether to perform a provisioning process. If the first device 300 does not want to perform the provisioning process, the invite message is ignored.

On the contrary, if the first device 300 wants to perform the provisioning process—that is, the first device 300 wants to join the mesh network —, the first device 300 sends a capability message in response to the invite message (S10030).

The capability message may contain information indicating whether the first device 300 supports setting up a security algorithm, a public key, information indicating whether the first device 300 is capable of outputting values to the user, and information indicating whether the first device 300 is capable of receiving values input by the user.

Public Key Exchange Step

Afterwards, the second device 400 sends a start message for starting provisioning to the first device 300 (S10040).

In situations where public keys are not available using an out-of-band technology, the second device 400 and the first device 300 exchange their public keys (S10050 and S10060).

On the contrary, in situations where public keys are available using an out-of-band mechanism, the second device 400 may send an ephemeral public key to the first device 300 and read a static public key from the first device 300 using an out-of-band technology.

Afterwards, the second device 400 performs an authentication process with the first device 300 and authenticates the first device 300 (S10070).

Distribution-of-Provisioning-Data Step

Once the first device 300 is authenticated, the second device 400 and the first device 300 calculate and generate a session key.

Afterwards, the second device 400 sends provisioning data to the first device 300 (S10080).

The provisioning data may contain an application key, a device key, a network key, IVindex, a unicast address, etc.

Upon receiving the provisioning data, the first device 300 sends a completion message in response to it, and completes the provisioning process (S10090).

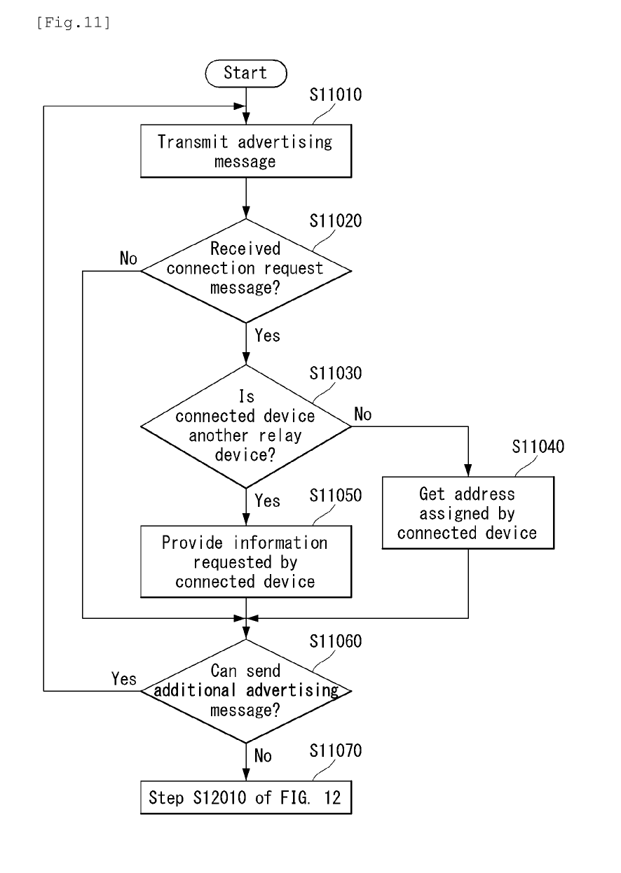

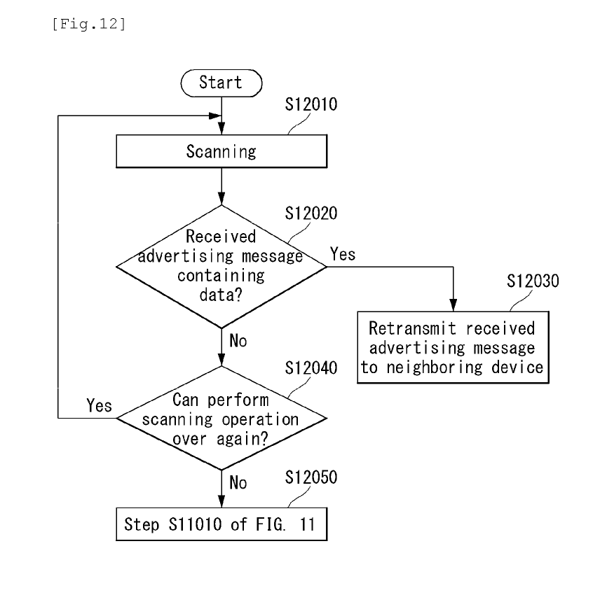

FIGS. 11 and 12 are flowcharts illustrating an example of a relay device's operation in a Bluetooth mesh network to which the present invention is applicable.

Referring to FIGS. 11 and 12, when a relay device in a Bluetooth mesh network receives a message from a neighboring device (edge device or relay device), it forwards the received message to neighboring devices (edge devices or relay devices).

Specifically, a relay device sends an advertising message, in order to connect to nearby relay devices or edge devices, or in order to transfer data (S11010). The advertising message may be sent over an advertising channel.

The term “advertising message” is merely an example, and may be replaced with other terms such as “advertising PDU”, “advertising packet”, etc.

If the relay device has not received a connection request message in response to the advertising message (S11020), it determines whether it can send an additional advertising message (S11060).

If the relay device can send the additional advertising message, it goes back to the step S11010 and sends the advertising message.

On the contrary, if the relay device cannot send the advertising message, it changes to scanning mode, as shown in the step S12010 of FIG. 12, and scans messages from nearby devices (S11070).

When the relay device receives a connection request message in response to the advertising message (S11020), it is connected to the device that has sent this connection request message through a connection procedure.

If the connected device is another relay device (S11030), it may provide information requested by the another relay device (S11050).

On the contrary, if the connected device is not a relay device (S11030), it may get an address assigned by the connected device (S11040).

Afterwards, the relay device determines whether it can send an additional advertising message. If it can, the relay device goes back to the step S11010 and sends the additional advertising message.

If it cannot, the relay device changes to scanning mode, as shown in the step S12010 of FIG. 12, and receives messages from nearby devices (S12010).

Upon receiving an advertising message containing data during the scanning operation (S12020), the relay device performs a relay operation for retransmitting the advertising message to a neighboring device (S12030).

On the contrary, if the relay device has not received the advertising message during the scanning operation, it may determine whether it can perform the scanning operation over again (S12040).

If it can, the relay device goes back to the step S12010 and performs the scanning operation.

If it cannot, the relay device goes back into advertising mode and sends the advertising message (S12050).

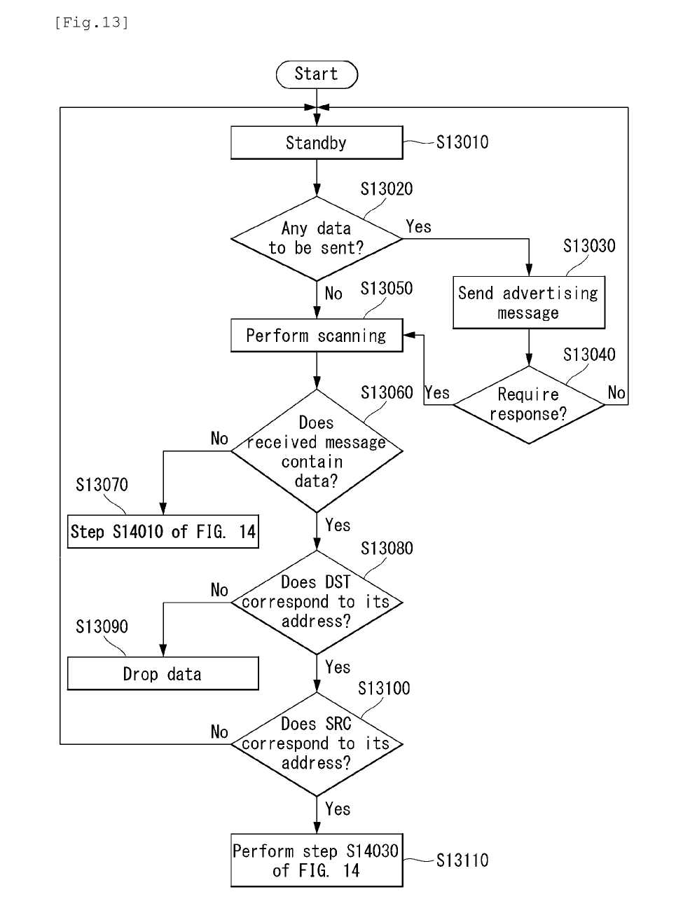

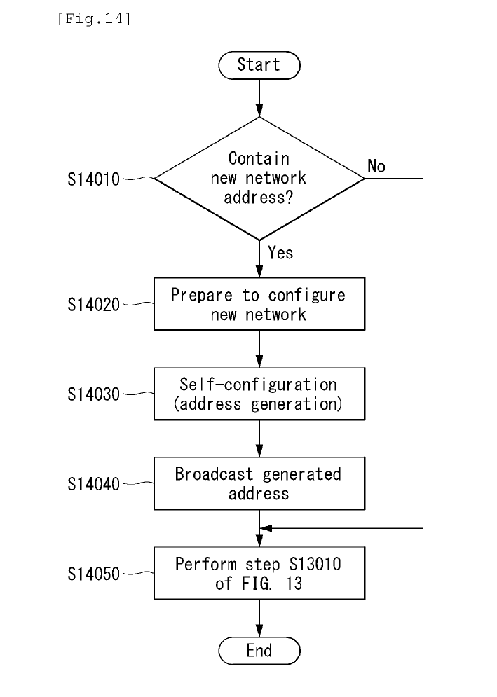

FIGS. 13 and 14 are flowcharts illustrating an edge device's operation in a Bluetooth mesh network to which the present invention is applicable.

Referring to FIGS. 13 and 14, an edge device in a Bluetooth mesh network may send or receive data to or from a relay device, and upon receiving data, may drop the data if the destination address does not correspond to its address.

Specifically, the edge device is basically on standby (S13010). The edge device on standby does not send or receive any data at all.

Afterwards, the edge device determines if there is data to be sent to other devices (S13020). If there is such data, the edge device goes into advertising state and sends an advertising message (S13030).

If there is no such data, the edge device goes into scanning state to receive messages from other devices and performs scanning (S13050).

In the step S13030, the edge device sends an advertising message containing that data to neighboring relay devices or edge devices.

If the data sent in the advertising message requires no response (S13040), the edge device goes into standby and does not send or receive data any longer (S13050).

On the contrary, if the data sent in the advertising message requires a response (S13040), the edge device goes into scanning state to receive a response and performs scanning (S13050).

The edge device in scanning state receives a message from other devices, and determines whether the received message contains data (S13060).

If the received message contains no data, the edge device may perform the step S14010 of FIG. 14. That is, the edge device determines whether the message contains a new network address or not (S14010). If not, the edge device goes into standby, as shown in the step S13010 of FIG. 13 (S14050).

On the contrary, if the received data contains a new network address, the edge device prepares to configure a new network (S14020), and generates an address through self-configuration (S14030).

Afterwards, the edge device broadcasts the generated address to other devices in the mesh network (S14040), and goes back into standby (S14050).

If the message received in the step S13060 contains data, the edge device determines whether or not the value of the DST field indicating the destination address of the data corresponds to its address (S13080).

If the value of the DST field does not correspond to its address, the edge device drops the received message. If the value of the DST field corresponds to its address, the edge device determines whether or not the value of the SRC field indicating the address of the device (source device) that has sent the message corresponds to its address (S13100).

If the value of the SRC field does not correspond to its address, the edge device goes back into standby (S13010).

On the contrary, if the value of the SRC field corresponds to its address, the edge device may perform the step S14030 of FIG. 14. That is, the edge device generates an address through self-configuration (S14030).

Afterwards, the edge device broadcasts the generated address to other devices in the mesh network (S13040), and goes back into standby (S14050).

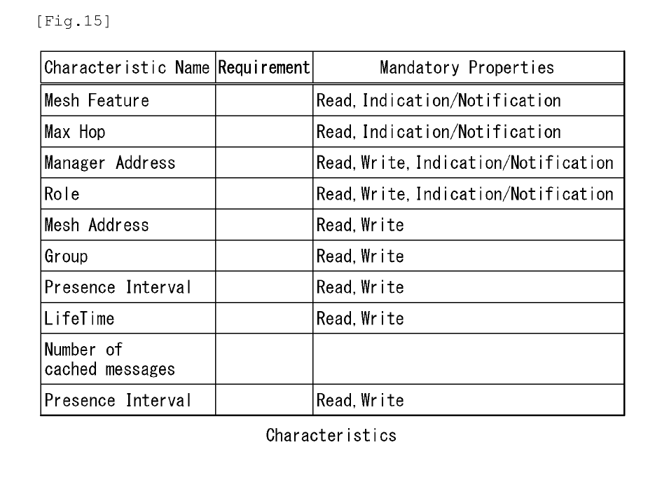

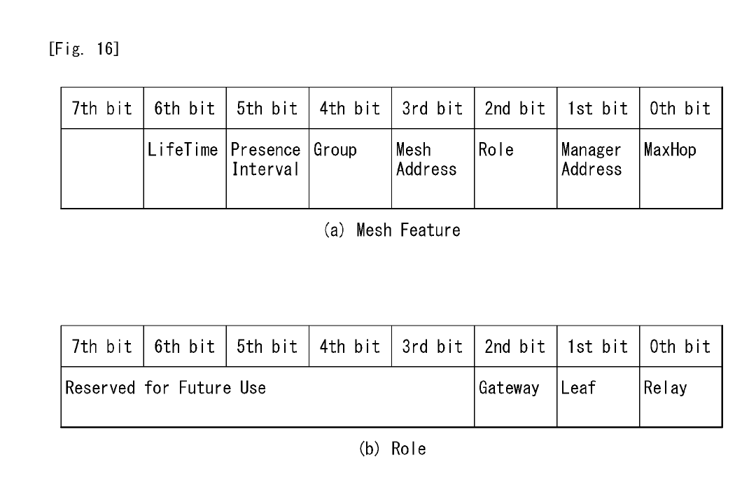

FIGS. 15 and 16 are views illustrating an example of the characteristics of Bluetooth LE to which the present invention is applicable.

Referring to FIGS. 15 and 16, on the basis of characteristics stored in a GATT database, particular functions may be set up for devices included in a Bluetooth mesh network, or a device's information may be acquired.

Specifically, on the basis of the characteristics specified in FIG. 15, the second device 400 may acquire information related to the mesh network from the first device 200, or set up a particular function related to the mesh network.

Descriptions of the characteristics will be made below.
Mesh Feature: information about the functions related to the mesh network that can be provided by the relevant device, which tells whether the following characteristics are supported or not.
   Max Hop
   Manager Address (mesh address assignment)
   Role
   Group
   Present Interval (if unavailable, the default value is used)
   LifeTime (if unavailable, the default value is used)
Max Hop: the maximum hop value (which may be an integer) required to deliver a message in the mesh network. It indicates the maximum TTL value used to broadcast a message
Manager Address: the address of Manager Node in the mesh network (for example, Mesh Network Address (16 bits) or Device Public Address (48 bits)).
Role: the role of the device operating in the mesh network
Mesh Address: the address of the device in the mesh network (it can be used for transfer using a flooding or routing technique)
Group: it indicates whether the device supports the Group function.
Presence Interval: the interval at which the device sends a presence message to announce its presence in the mesh network (it can be a time duration or a specific time (e.g., 20:00:00, Jun. 15, 2015).
LifeTime: time information used to determine whether nodes are present in the mesh network, which is reset when a presence message is received (it can be a time duration or a specific time (e.g., 20:00:00, Jun. 15, 2015).
Number of cached messages: the number of messages that can be stored in cache in the mesh network.
Replication: it indicates whether to relay a received message that is redundant.

The Mesh Feature indicates the characteristics that can be supported by the device, which lets the device on the other side know which characteristics the device supports.

(a) of FIG. 16 illustrates an example of the Mesh Feature characteristics.

The Role characteristic may set the role of the device or indicate the current role of the device in the mesh network.

The device on the other side may become aware of the role of the device by reading the Role characteristic, and the device may perform a particular role by setting the Role characteristic.

(b) of FIG. 16 illustrates an example of the Role characteristic.

The LifeTime is a characteristic for determining whether nodes forming the mesh network are present or not.

For example, if no presence message is received from a particular node for the duration of the LifeTime, it is determined that the particular node is not present in the mesh network, and the information related to the particular node may be erased.

In this case, the value of the LifeTime should be greater than the value of the Presence Interval indicating the interval at which the presence message is sent.

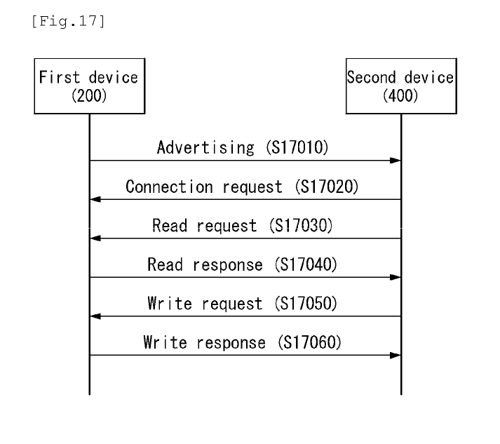

FIG. 17 is a flowchart illustrating an example of a method for setting up a function supported by a device in a Bluetooth mesh network to which the present invention is applicable.

Referring to FIG. 17, the second device 400 may acquire information on characteristics that can be provided by the first device 200, or set up a particular function for the first device 200.

Specifically, the first device 200 sends an advertising message to the second device 400 (S17010). The advertising message may be referred to as an advertising PDU (Pack Data Unit), an advertising packet, an advertisement, an advertising frame, an advertising physical channel PDU, etc.

The advertising message may contain information on services supported by the first device 200, information related to the first device 200, and information on the role of the first device 200.

For example, the first device 200 may send to the second device 400 an advertising message containing information that the first device 200 provides the functions related to the mesh network specified in FIGS. 15 and 16.

Having received the advertising message, the second device 400 may become aware that the first device 200 provides the functions related to the mesh network, and may send a connection request message to the first device 200 to establish a Bluetooth LE connection (S17020).

Afterwards, the second device 400 sends a read request message to the first device 200, in order to check for characteristics that can be set for the first device 200 (S17030).

Having received the read request message, the first device 200 sends a read response message containing the Mesh Feature of FIG. 16 to the second device 400 (S17040).

If the first device 200 forms the mesh network, the first device 200 may support the Manager Address characteristic and Presence Interval characteristic specified in FIG. 15.

Afterwards, if the second device 400 wants to set a particular one of the characteristics supported by the first device 200, it may send a write request message (S17050).

For example, if the second device 400 wants to set the address of a particular device as the Manager Address, it may transmit a write request message containing the address of the particular device, or if the second device 400 wants to set the Presence Interval to a specific value, it may transmit a write request message containing the Presence Interval value.

Having received the write request message, the first device 200 sets a particular characteristic as requested, and sends a write response message to the second device 400 (S17060).

With this method, the second device 400 may check for characteristics related to the mesh network that can be provided by the first device 200, and may set these characteristics to a specific value.

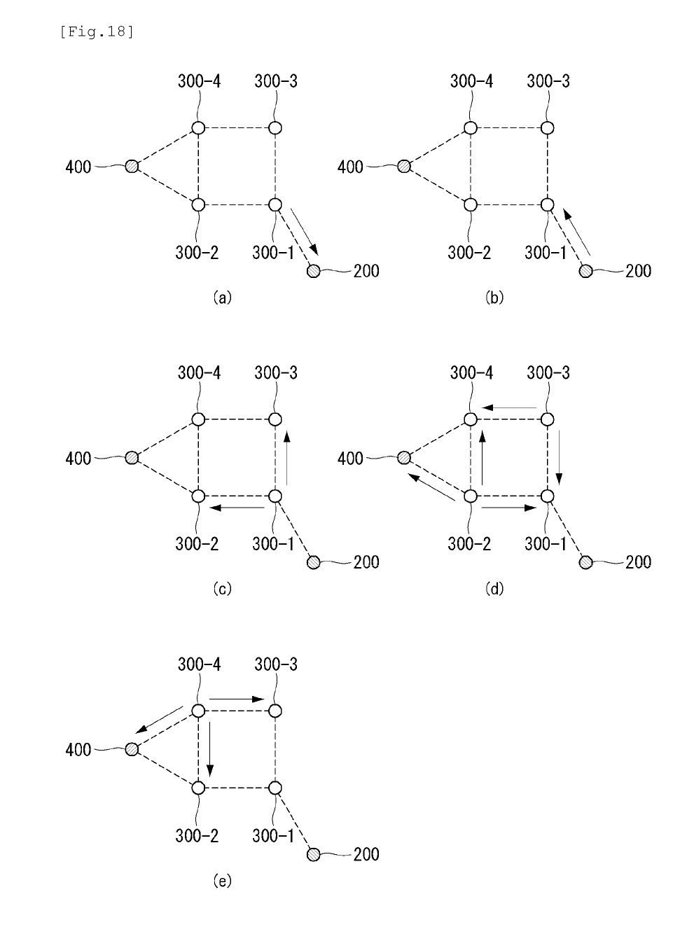

FIGS. 18 through 20 are flowcharts illustrating an example of a method for setting the address of a device and sending the device's information in a Bluetooth mesh network to which the present invention is applicable.

Referring to FIGS. 18 through 20, if a first device 200 joins the mesh network, the first device 200 may be assigned an address it will use in the mesh network, and may send information on the first device 200 to the devices forming the mesh network using a flooding technique.

Specifically, (a) the first device 200 may receive an advertising message containing the address of a first relay device 300-1 from the first relay device 300-1 forming the mesh network.

Having received the advertising message, the first device 200 may join the mesh network by the method explained with respect to FIG. 10, and may be assigned an address it will use in the mesh network, based on the address of the manager device of the mesh network.

The address assignment process will be discussed in detail later.

(b) After getting the address assigned to it, the first device 200 may broadcast an advertising message containing the address and the first device 200's information to nearby devices.

(c) Having received the advertising message, the first relay message 300-1 may broadcast it to nearby devices.

(d) Afterwards, having received the advertising message from the first relay device 300-1, a second relay device 300-2 and a third relay device 300-3 broadcast it to nearby devices.

In this case, a fourth relay device 300-4 may discard the advertising message that is received later, as explained with respect to FIGS. 7 and 8.

(e) The fourth relay device 300-4 broadcasts the advertising message to nearby relay devices. However, the second relay device 300-2, third relay device 300-3, and second device 400 may discard the advertising message sent from the fourth relay device 300-4 because they have already received it.

With this method, the first device 200 may send a generated address and its information to the devices forming the mesh network.

Afterwards, if the first device 200 receives a response from any of the devices forming the mesh network, saying that the generated address is redundant, it may perform the whole procedure all over again, starting from the address assignment process.

On the contrary, if the first device 200 receives no such response, it may use the generated address as its address in the mesh network.

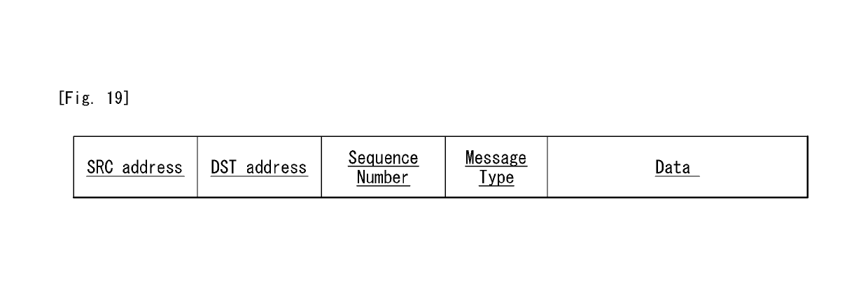

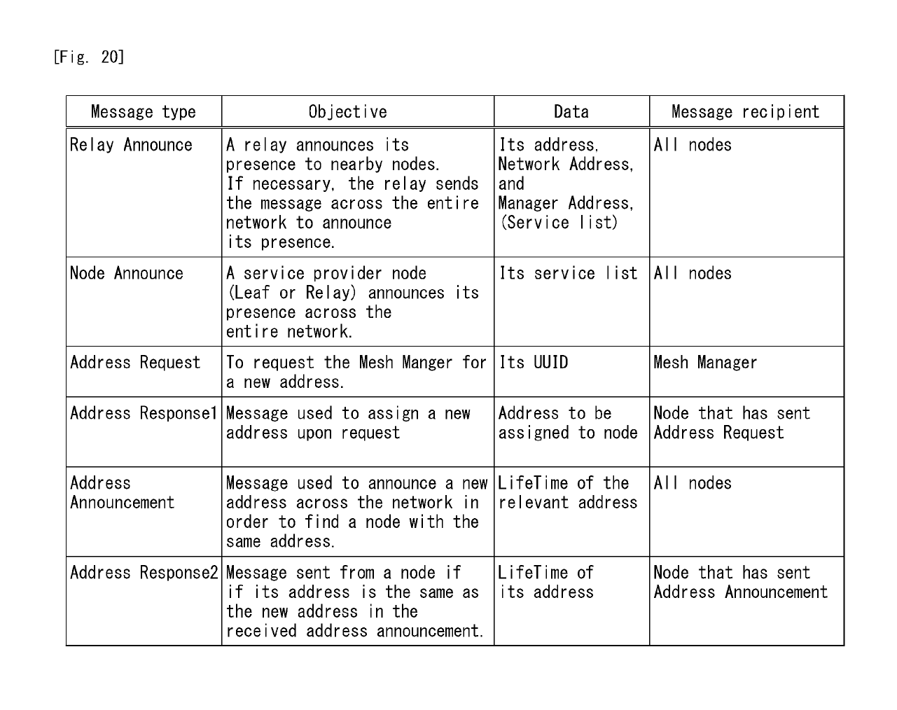

FIG. 19 illustrates an example of a message format for address assignment and data transfer in the mesh network. FIG. 20 illustrates an example of objectives, data, and recipients for each message type.

As shown in FIG. 19, the SRC address field contains the address of a source device, and the DST address field contains the address of a destination device.

The Sequence Number field is a field indicating the sequence number of a message. If a device receives a redundant message, it may figure out the sequence number of this message, based on the Sequence Number field, and discard the message if it is the one that is received later.

The Message Type field is a field indicating the type of a message, which may contain information indicating one of the message types listed in FIG. 20.

The Data field is a field containing actual data, which may contain data for one of the message types listed in FIG. 20.

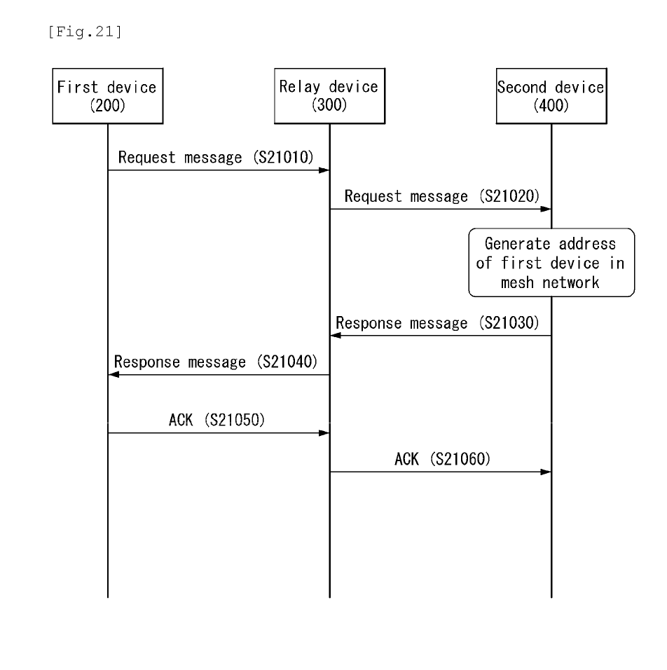

FIG. 21 is a flowchart illustrating an example of a method for assigning an address to a device in a Bluetooth mesh network to which the present invention is applicable.

Referring to FIG. 21, if a first device 200 joins a mesh network, it may request a second device 400, the manager device, to assign an address to the first device 200.

Specifically, the first device 200 may join a mesh network and then send a request message requesting the second device 400 to assign an address it will use in the mesh network (S21010).

The request message may be in the format shown in FIG. 19, and its message type may be Address Request listed in FIG. 20.

Also, the request message may contain the first device 200's LifeTime information shown in FIG. 15.

If the first device 200 is not able to find out the address of the second device 400, it may broadcast the request message. In this case, relay devices may discard the request message.

If the requested message is broadcast, the request message may contain a TTL value indicating the number of relays for the message, and the TTL value may be set equal to the maximum hop value shown in FIG. 15.

Afterwards, having received the request message by the method explained with respect to FIG. 7, a relay device 300 may send the request message to the second device 400 (S21020).

Having received the request message, the second device 400 may generate an address the first device 200 will use in the mesh network. For example, the second device 400 may generate an address by a hash algorithm.

In a case where the expiry time of the address is set, the address will expire at the set time.

Accordingly, the first device 200 may extend the expiry time by getting a new address assigned to it before the expiry of the address or by making an update request.

Once an address is generated and the expiry time of the address is set, the second device 400 may send to the relay device 300 a response message (first response message) containing time information indicating the expiry time and the UUID of the first device 200 (S21030). Then, the relay device 300 may send the response message to the first device 200 (S21040).

The response message may be in the format shown in FIG. 19, and its message type may be Address Response1 listed in FIG. 20.

Having received the address assigned to it through the response message, the first device 200 may send an ACK message (acknowledgment message) in order to notify that it has the address assigned to it (S21050). Then, the relay device 300 may send the ACK message to the second device 400 (S21060).

The ACK message may contain new expiry time information. The second device 400, having received the ACK message, may update the expiry time of the address assigned to the first device 200, based on the new expiry time information.

With this method, if the first device 200 joins the mesh network, it may be assigned an address it will use in the mesh network.

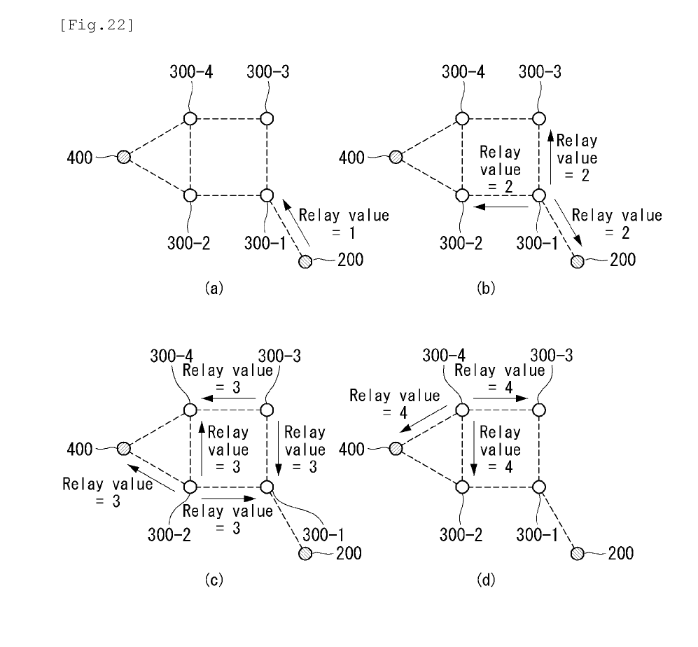

FIG. 22 is a view illustrating an example of a method for calculating the number of hops between devices in a Bluetooth mesh network to which the present invention is applicable.

Referring to FIG. 22, a first device 200 may calculate the number of hops to a second device 400 by sending a message to the second device 400.

Specifically, (a) the first device 200 may broadcast a presence message (first message) for sending/receiving information to/from other devices.

The format of the presence message may be identical to that shown in FIG. 19. The SRC address field may contain the address of the first device 200, and the DST address field may contain a value indicating the broadcast.

The Data field may contain a TTL value or relay value indicating the number of relays, a maximum hop value explained with respect to FIG. 15, a LifeTime value, and a Present Interval value.

The LifeTime value should be greater than the Presence Interval value, and the TTL value or relay value may be set to ‘1’.

Having received the presence message, a first relay device 300-1 may store an NHOP value of 1 indicating the number of hops from the first device 200.

(b) Afterwards, the first relay device 300-1 relays the presence message to nearby devices, incrementing the TTL value or relay value indicating the number of relays by 1.

Having received the presence message, second and third relay devices 300-2 and 300-3 may store an NHOP value of 2 indicating the number of hops from the first device 200. The first device 200 may discard the presence message sent from the first relay device 300-1.

(c) The second relay device 300-2 and the third relay device 300-3 relay the presence message to nearby devices, incrementing the TTL value or relay value indicating the number of relays by 1.

Having received the presence message, a fourth relay device 300-4 and the second device 400 may store an NHOP value of 3 indicating the number of hops from the first device 200. As explained with respect to FIG. 7, the fourth relay device 300-4 may discard the presence message sent from the third relay device 300-3.

(d) The fourth relay device 300-4 relays the presence message to nearby devices, incrementing the TTL value or relay value indicating the number of relays by 1.

In this case, since the second relay device 300-2, third relay device 300-3, and second device 400 have already stored the number of hops from the first device 200, they may discard the presence message sent from the fourth relay device 300-4.

With this method, the devices in the mesh network may calculate and store the minimum number of hops from the first device 200.

In another exemplary embodiment of the present invention, if the presence message sent to the first relay device 300-1 from the first device 200 contains a maximum hop value, the TTL value or relay value may be set equal to the maximum hop value.

Afterwards, each time the presence message is relayed by a relay device, the TTL value or relay value decreases by 1. The relay devices or the second device 400 may store the NHOP value, i.e., the number of hops from the first device 200, which is equal to the maximum hop value minus the TTL value or relay value.

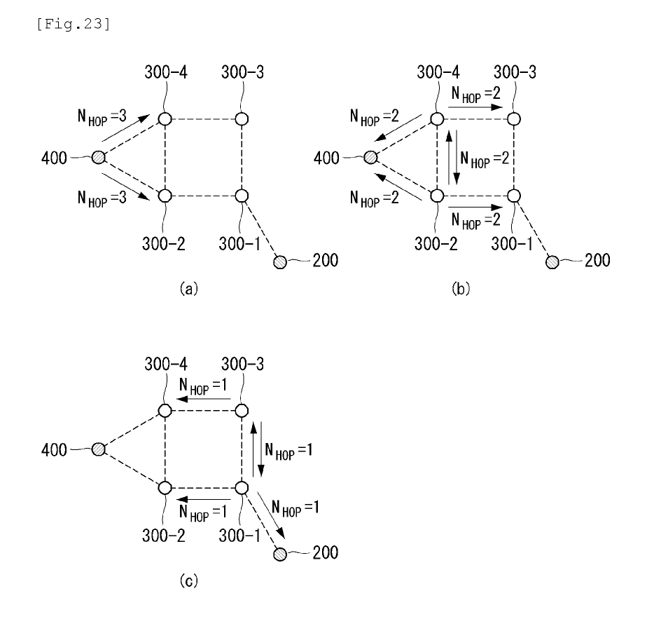

FIG. 23 is a view illustrating an example of a method for sending data via a calculated number of hops in a Bluetooth mesh network to which the present invention is applicable.

Referring to FIG. 23, the NHOP value calculated and stored by the method of FIG. 22 may be contained in a message to be sent. In this way, the message will be kept from continuing to be relayed in a flooding technique.

Specifically, (a) the second device 400 broadcasts a message (second message) containing the NHOP value calculated by the method explained with respect to FIG. 22 to nearby devices, in order to send the message to the first device 200.

The second message may be in the format shown in FIG. 19, and the DST Address field may contain the address of the first device 200.

(b) Having received the second message, the second relay device 300-2 and the fourth relay device 300-4 relay the second message to nearby devise, decrementing the NHOP value by 1.

(c) Afterwards, the first relay device 300-1 and the third relay device 300-3 relay the second message to nearby devices, decrementing the NHOP value by 1.

In this case, the first device 200 may receive the second message from the first relay device 300-1, and the first to fourth relay devices 300-1 to 300-4 do not relay the second message any longer since the NHOP value of the received second message is ‘1’.

With this method, it is possible to prevent a message from continuing to be relayed when sending a message using a flooding technique over a Bluetooth mesh network, thereby resulting in a decrease in traffic.

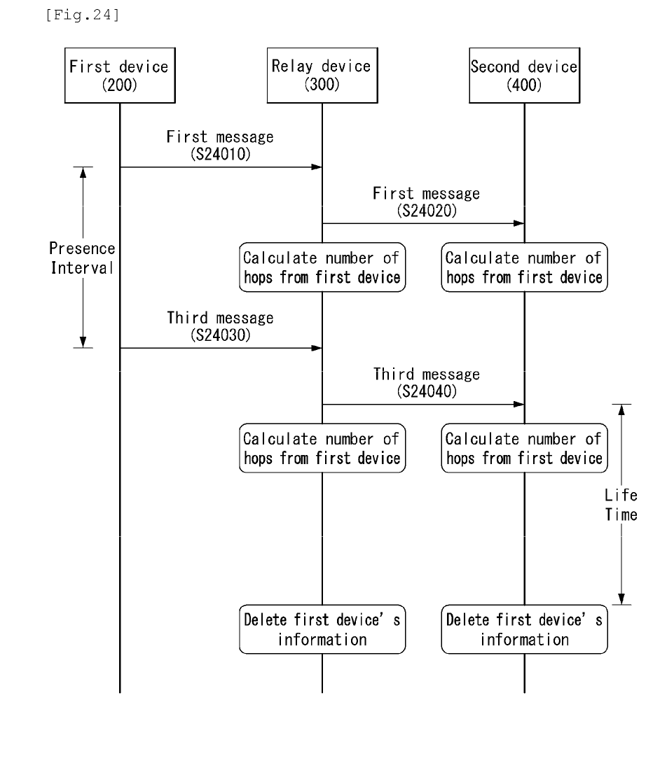

FIG. 24 is a flowchart illustrating an example of a method for calculating the number of hops and sending a device's information in a Bluetooth mesh network to which the present invention is applicable.

Referring to FIG. 24, devices forming a Bluetooth mesh network may send a presence message at regular intervals. If a certain device does not send a presence message for a specific amount of time, it is determined that this device is not present in the mesh network.

Specifically, a first device 200 may send a first message, the presence message described with respect to FIG. 22, to a relay device 300 (S24010), and the relay device 300 may relay the first message to a second device 400 (S24020).

In this case, the relay device 300 and the second device 400 may calculate the number of hops from the first device 200 by the method described with respect to FIG. 22.

Afterwards, the first device 200 may send a third message, a presence message, to the relay device 300 at the presence interval described with respect to FIG. 15 (S24030). The relay device 300 may relay the third message to the second device 400 (S24040).

The relay device 300 and the second device 400 may calculate the number of hops from the first device 200 by the method described with respect to FIG. 22, in order to check for a change in the number of hops from the first device 200.

If the first device 200 does not send a presence message during the LifeTime described with respect to FIG. 15 after sending the third message, the relay device 300 and the second device 400 may determine that the first device 200 is not present in the mesh network and erase the first device 200's information.

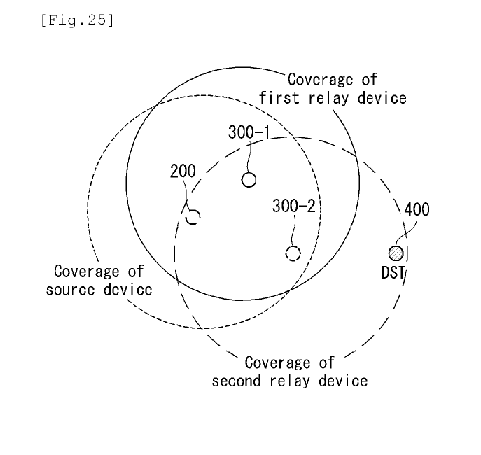

FIG. 25 is a flowchart illustrating an example of a method of relaying a received message that is redundant, in a Bluetooth mesh network to which the present invention is applicable.

Specifically, when sending a message using the above-explained flooding technique, if the second relay device 300-2 receives a message from the first device 200, it discards the message sent from the first relay device 300-1 without relaying it.

That is, the second relay device 300-2 discards a received message that is redundant.

However, in a case where the redundant message is an important message or the message that has been sent earlier is lost, it needs to be relayed. Accordingly, a method of relaying a received message even if the message is redundant will be discussed below.

First, a redundant message may be relayed using the Replication characteristic among the characteristics listed in FIG. 15. If the Replication characteristic is Off, the second relay device 300-2 may discard a redundant message without relaying it. On the other hand, if the Replication characteristic is On, the second relay device 300-2 may relay a received message regardless of whether the message is redundant or not.

Second, the DST field indicating the address of a destination device of a message may be set to a specific value for relaying the message regardless of whether the message is redundant or not.

That is, if the DST Address field of a message is set to a specific value, the second relay device 300-2 may relay the message, regardless of whether the message is redundant or not, or regardless of the value of the Sequence Number field.

With this method, even a redundant message may be relayed.

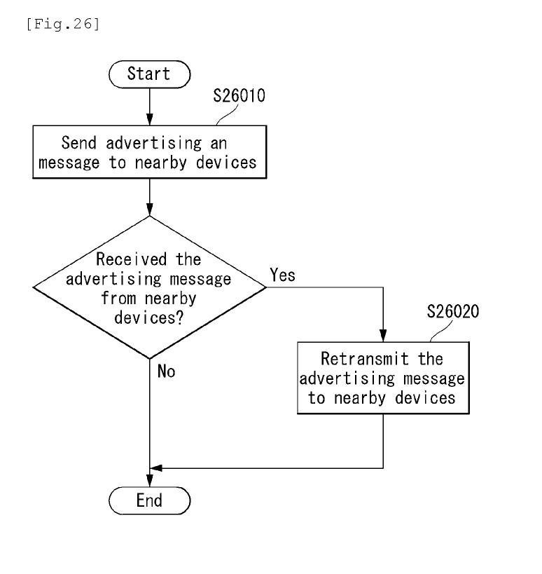

FIG. 26 is a view illustrating an example of a method of checking if a sent message has been received properly by nearby devices to which the present invention is applicable.

When a first device 200 sends data to nearby relay devices or a destination device through an advertising message, the nearby relay devices or the destination device do not send a response message to the advertising message.

Also, the first device 200 changes to sleep state after sending the advertising message and cannot receive advertising messages from nearby devices. Thus, the first device 200 is not able to check if the sent advertising message has been transmitted properly, making it difficult to decide whether to retransmit the advertising message or not.

To solve this problem, the present invention proposes a method of determining whether to retransmit an advertising message the first device 200 has sent by checking if the advertising message has been transmitted properly.

Specifically, the first device 200 sends an advertising message to nearby devices over a Bluetooth mesh network (S26010).

Afterwards, if the first device 200 receives the advertising message from the nearby devices, it may determine that the advertising message has been transmitted properly and not retransmit the advertising message.

On the contrary, if the first device 200 does not receive the advertising message from the nearby devices, it may determine that the advertising message has not been transmitted properly and retransmit the advertising message to nearby devices.

With this method, the first method 200 may retransmit a message it has sent by checking if the message has been transmitted properly.

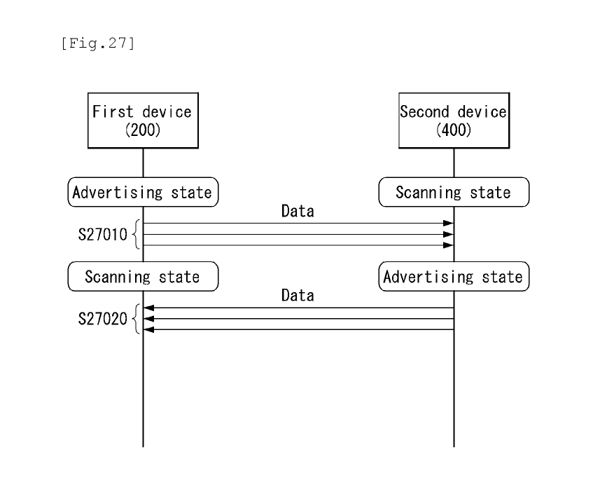

FIG. 27 is a view illustrating another example of a method of checking if a sent message has been received properly by nearby devices to which the present invention is applicable.

Referring to FIG. 27, when a first device 200 receives the advertising message it has sent from a second device 400, it may determine that the advertising message has been transmitted properly.

Specifically, if there is data to be sent to the second device 400, the first device 200, in advertising state, may send an advertising message containing the data to the second device 400 (S27010).

The second device 400, in scanning state, may receive the advertising message and then change to advertising state and transmit the advertising message to nearby devices (S27020).

After the step S27010, the first device 200 may change to scanning state and receive messages from nearby devices.

If the first device 200 receives the advertising message it has sent from the second device 400, it may determine that the advertising message has been transmitted properly and not retransmit the advertising message.

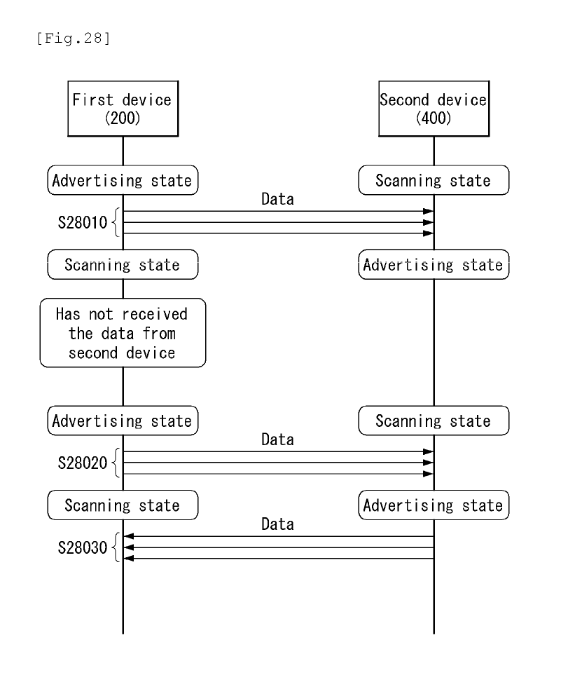

FIG. 28 is a view illustrating yet another example of a method of checking if a sent message has been received properly by nearby devices to which the present invention is applicable.

Referring to FIG. 28, if a first device 200 has not received the advertising message it has sent from a second device 400, it may determine that the advertising message has not been transmitted properly and retransmit the advertising message.

To begin with, the step S28010 is identical to the step S27010 of FIG. 27, so a description thereof will be omitted.

If the second device 400, in scanning state, has not received the advertising message properly, it cannot transmit the advertising message to nearby devices even when in advertising state.

After the step S27010, the first device may change to scanning state and receive messages from nearby devices.

If the first device 200 has not received the advertising message it has sent from the second device 400, it may determine that the advertising message has not been transmitted properly and retransmit the advertising message.

That is, the first device 200 may change back into advertising state and send the advertising message to nearby devices (S28020).

If the second device 400, in scanning state, has received the advertising message properly, it may change to advertising state and send the advertising message to nearby devices (S28030).

After the step S28030, the first device 200 may change back into scanning state and receive messages from nearby devices.

If the first device 200 receives the advertising message it has sent from the second device 400, it may determine that the advertising message has been transmitted properly and not retransmit the advertising message.

With this method, the first device 200 may check if a message it has sent has been transmitted properly, and if the message has not been transmitted properly, may retransmit the message.

The present invention disclosed in this specification is not limited to the configurations and methods of the above-described embodiments, and all or some of the embodiments may be selectively combined to achieve various modifications.

The present invention described above is not limited to the aforementioned embodiments and the accompanying drawings. It will be apparent that those skilled in the art can make various substitutions, modifications and changes thereto without departing from the technical spirit of the present invention.

What is claimed is:

1. A method for transmitting data from a first device to a second device over a Bluetooth mesh network, the method comprising:
receiving a first message from at least one device among the second device and a relay device included in the Bluetooth mesh network, in order to calculate the number of hops between the first and second devices;
calculating the number of hops based on the first message; and
transmitting a second message containing the number of hops and data to at least one device among the second device or the relay device,
wherein the first message contains at least one between a maximum hop value indicating the maximum number of hops in the mesh network or a relay value indicating the number of relays for the first message.

2. The method of claim 1, wherein a initial value of the relay value is equal to the maximum hop value, and decreases each time the first message is retransmitted.

3. The method of claim 1, wherein the number of hops is the maximum hop value minus the relay value.

4. The method of claim 1, wherein the first message is periodically transmitted, and further contains at least one between transmission interval information indicating the transmission interval of the first message or time information indicating an expiry time for determining whether the second device is present in the mesh network.

5. The method of claim 4, wherein the method further comprises erasing the first device's information if the first message is not received until the expiry time.

6. The method of claim 1, wherein the initial relay value is set to ‘1’, and increases each time the first message is retransmitted.

7. The method of claim 6, wherein the number of hops is set equal to the relay value.

8. The method of claim 1, wherein the number of hops decreases each time the the second message is transmitted.

9. The method of claim 1, wherein the second message further contains address information indicating the address of the second device in the Bluetooth mesh network.

10. The method of claim 1, further comprising retransmitting the second message to at least one device among the second device and relay devices, if the second message is not received from at least one device among the second device and relay devices for a specific amount of time.

11. A method for sending data from a first device to a second device over a Bluetooth mesh network, the method comprising:
transmitting a request message to request the second device to assign an address to the first device in the Bluetooth mesh network;
receiving from the second device a first response message containing first address information indicating the assigned address;
transmitting a second response message indicating the reception of the first address information to the second device; and
broadcasting an acknowledgment message containing the first address information, wherein the acknowledgment message contains time information indicating the expiry time of the first address information.

12. The method of 11, further comprising, if the first address information is identical to second address information indicating the address of at least one device included in the Bluetooth mesh network, receiving a third response message from the at least one device, indicating that the first address information is identical to the second address information.

13. The method of claim 11, wherein the third response message contains second time information indicating the expiry time of the second address information.

14. A device which uses a method for transmitting data from a first device to a second device over a Bluetooth mesh network, the device comprising:
a communication part for communicating with external devices in a wireless or wired manner; and
a processor functionally connected to the communication part,
wherein the processor controls the operation of receiving a first message from at least one device among the second device and a relay device included in the Bluetooth mesh network, in order to calculate the number of hops between the first and second devices, the operation of calculating the number of hops based on the first message, and the operation of transmitting a second message containing the number of hops and data to at least one device among the second device or the relay device,
wherein the first message contains at least one between a maximum hop value indicating the maximum number of hops in the mesh network or a relay value indicating the number of relays for the first message.
